(19) United States
(12) Patent Application Publication
(10) Pub. No.: US 2020/0288031 A1
(43) Pub. Date: Sep. 10, 2020

(54) INFORMATION PROCESSING APPARATUS EQUIPPED WITH STORAGE DEVICE, CONTROL METHOD THEREFOR, AND STORAGE MEDIUM

(71) Applicant: CANON KABUSHIKI KAISHA, Tokyo (JP)

(72) Inventor: Masahiro Takizawa, Tokyo (JP)

(21) Appl. No.: 16/806,179

(22) Filed: Mar. 2, 2020

(30) Foreign Application Priority Data
Mar. 6, 2019 (JP) 2019-040666

(51) Int. Cl. H04N 1/00; G06F 9/48; G06F 9/46

(52) U.S. Cl. CPC H04N 1/00925; G06F 9/4843; G06F 9/463; G11B 19/04; H04N 1/0009; H04N 1/00037; H04N 1/0097

(57) ABSTRACT

An information processing apparatus which is capable of reducing the risk of storage device failure. The information processing apparatus is equipped with a storage device that can be accessed a limited number of times. A control unit performs control to write data into the storage device. The control unit determines whether or not to allow writing into the storage device based on an operating state of the information processing apparatus.

### BACKGROUND OF THE INVENTION

### Field of the Invention

The present invention relates to an information processing apparatus, a control method therefor, and a storage medium.

### Description of the Related Art

An MFP which is an information processing apparatus equipped with a storage device such as an HDD or an SSD is known. The MFP stores multiple types of data such as image data and programs in the storage device. The storage device such as an HDD or an SSD can be accessed a limited number of times. When the number of times the storage device has been accessed becomes equal to or greater than a prescribed value determined in advance, the storage device tends to fail. To reduce the risk of storage device failure, a technique to store data in a DRAM, which has a smaller storage capacity than the storage device but has a longer lifespan than the storage device, has been proposed. For example, when the amount of data is greater than a predetermined threshold value, a storage location for the data is set at the storage device, and when the amount of data is equal to or smaller than the predetermined threshold value, the storage location for the data is switched from the storage device to the DRAM (see, for example, Japanese Laid-Open Patent Publication (Kokai) No. 2002-103699). Switching data storage locations in this manner can decrease the frequency of access to the storage device, and thus reduce the risk of storage device failure.

However, if switching of data storage locations is controlled based on the amount of data as described above, it is necessary to access the storage device each time when, for example, a process in which data in an amount equal to or smaller than the predetermined threshold value is frequently written into the storage device is carried out. According to the prior art, when this process is carried out, the frequency of access to the storage device cannot be decreased, and hence the risk of storage device failure cannot be reduced.

### SUMMARY OF THE INVENTION

The present invention provides an information processing apparatus which is capable of reducing the risk of storage device failure, a control method therefor, and a storage medium.

Accordingly, the present invention provides an information processing apparatus equipped with a storage device that can be accessed a limited number of times, comprising a control unit configured to perform control to write data into the storage device, wherein the control unit determines whether or not to allow writing into the storage device based on an operating state of the information processing apparatus.

According to the present invention, the risk of storage device failure can be reduced.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of an MFP which is an information processing apparatus according to an embodiment of the present invention.

FIG. 2 is a flowchart showing the procedure of an HDD writing process which is carried out by the MFP in FIG. 1.

FIG. 3 is a view useful in explaining determination in step S202 in FIG. 2.

FIG. 4 is a view useful in explaining determination in step S203 in FIG. 2.

FIG. 5 is a view useful in explaining storage areas in a DRAM in FIG. 1.

FIG. 6 is a timing chart useful in explaining operation of the MFP in FIG. 1.

FIG. 7 is a block diagram useful in explaining an arrangement of software modules in the MFP in FIG. 1.

FIG. 8 is a flowchart showing the procedure of a holding time period control process which is carried out by the MFP in FIG. 1.

FIG. 9 is a flowchart showing the procedure of a disk buffer writing process which is carried out by the MFP in FIG. 1.

FIG. 10 is a flowchart showing the procedure of a writing process in step S903 in FIG. 9.

### DESCRIPTION OF THE EMBODIMENTS

An embodiment of the present invention will now be described in detail with reference to the drawings. It should be noted that in the following description of the present embodiment, the present invention is applied to an MFP equipped with a storage device, but the present invention should not always be applied to the MFP, but may be applied to an information processing apparatus such as a client PC equipped with a storage device that can be accessed a limited number of times.

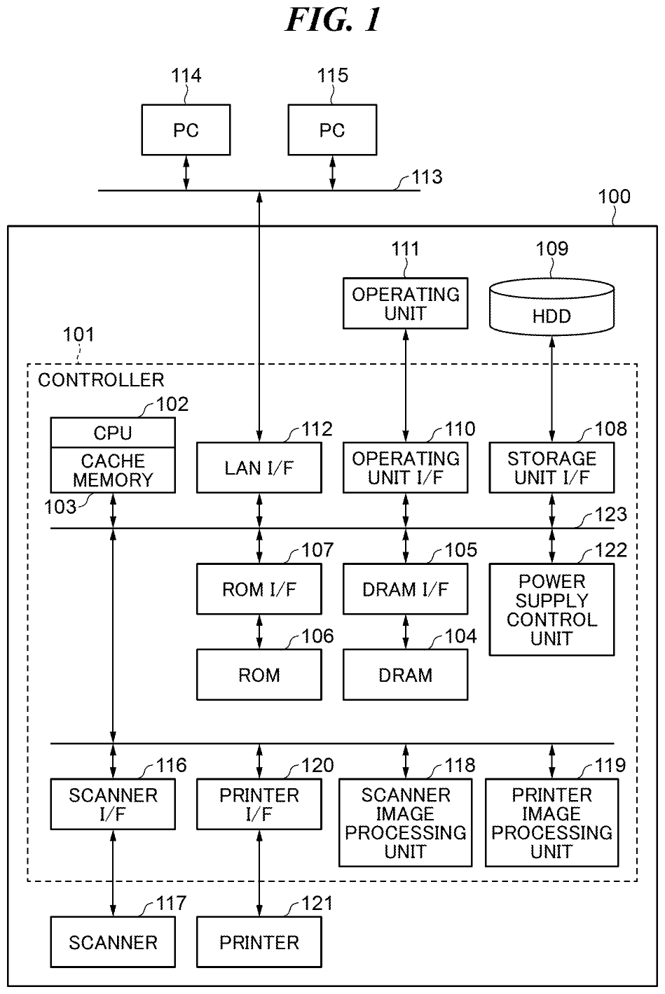

FIG. 1 is a block diagram schematically showing an arrangement of the MFP 100 which is an information processing apparatus according to the embodiment of the present invention.

Referring to FIG. 1, the MFP 100 has a controller 101, an HDD 109, an operating unit 111, a scanner 117, and a printer 121. It should be noted that the present embodiment is not limited to this arrangement, but the MFP 100 has only to have at least the controller 101 and the HDD 109. The MFP 100 is an image forming apparatus that carries out an image forming process. The controller 101 is connected to the HDD 109, the operating unit 111, the scanner 117, and the printer 121.

The controller 101 controls the entire system of the MFP 100. The controller 101 has a CPU 102, a DRAM 104, a DRAM I/F 105, a ROM 106, a ROM I/F 107, a storage unit I/F 108, an operating unit I/F 110, and a LAN I/F 112. The controller 101 also has a scanner I/F 116, a scanner image processing unit 118, a printer image processing unit 119, a printer I/F 120, and a power supply control unit 122. The CPU 102, the DRAM I/F 105, the ROM I/F 107, the storage unit I/F 108, the operating unit I/F 110, the LAN I/F 112, the scanner IF 116, the scanner image processing unit 118, the printer image processing unit 119, the printer I/F 120, and the power supply control unit 122 are connected to one another via a system bus 123.

The CPU 102 has a cache memory 103 in which data is temporarily stored. The CPU 102 performs various types of control by executing programs stored in the DRAM 104 and others. The DRAM 104 is connected to the DRAM I/F 105. The DRAM 104 is used as a work area for the CPU 102 and also used as an area in which data is temporarily stored. The DRAM 104 has a smaller storage capacity than the HDD 109 but has a longer lifespan than the HDD 109. The DRAM I/F 105 is a DRAM controller that connects the DRAM 104 to the system bus 123. The ROM 106 is connected to the ROM I/F 107. The ROM 106 is a read-only memory in which programs and setting data are stored. The ROM I/F 107 is a ROM controller that connects the ROM 106 to the system bus 123. The storage unit I/F 108 is, for example, a SATA controller. The storage unit IF 108 writes data read from the HDD 109 into the DRAM 104. The storage unit I/F 108 also writes data read from the DRAM 104 into the HDD 109. The HDD 109 is a nonvolatile storage device that can be accessed a limited number of times. In the present embodiment, when the load/unload cycle count of the HDD 109 has exceeded a predetermined value determined in advance, the HDD 109 tends to be broken, and hence, the HDD 109 is controlled so as to prevent its lifespan from decreasing.

The operating unit I/F 110 is connected to the operating unit 111. The operating unit 111 is a touch-panel device having a display function and an operating function. The operating unit 111 displays image data for display, which has been obtained from the operating unit I/F 110, and also sends information, which has been input to the operating unit 111 by a user, to the CPU 102.

The LAN I/F 112 carries out data communications with external apparatuses connected to the LAN 113. For example, the LAN I/F 112 sends scan image data, which has been generated by the scanner 117, to the PCs 114 and 115 connected to the LAN 113. The LAN I/F 112 also obtains image data to be printed from the PCs 114 and 115. The scanner I/F 116 is connected to the scanner 117. The scanner 117 reads an original placed thereon to generate scan image data. The scan image data is sent to the scan image processing unit 118 via the scanner I/F 116. The scanner image processing unit 118 performs image processing on the obtained scan image data. The scan image data that has been subjected to the image processing is stored in the DRAM 104. The printer image processing unit 119 performs image processing on image data stored in the DRAM 104 and sends the image data, which has been subjected to the image processing, to the printer 121 via the printer I/F 120. The printer I/F 120 is connected to the printer 121. The printer I/F 120 prints the obtained image data, which has been subjected to the image processing, on a sheet. The power supply control unit 122 controls supply of power to each unit of the MFP 100.

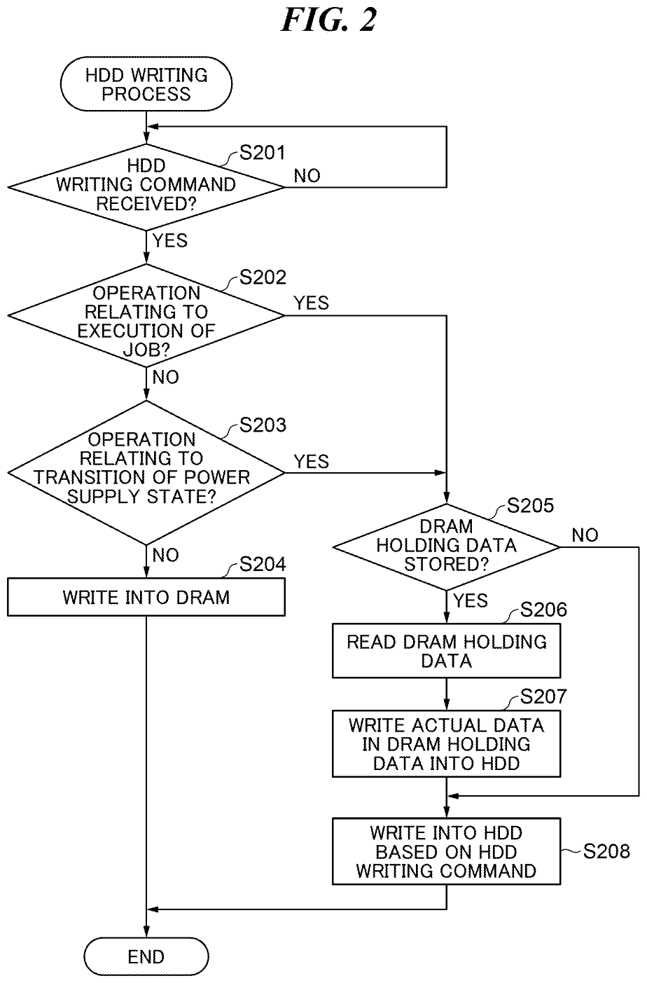

FIG. 2 is a flowchart showing the procedure of an HDD writing process which is carried out by the MFP 100 in FIG. 1. The process in FIG. 2 is implemented by the CPU 102 executing a program stored in the ROM 106 or the HDD 109. The process in FIG. 2 is carried out when an HDD writing command that requests writing of data into the HDD 109 is issued.

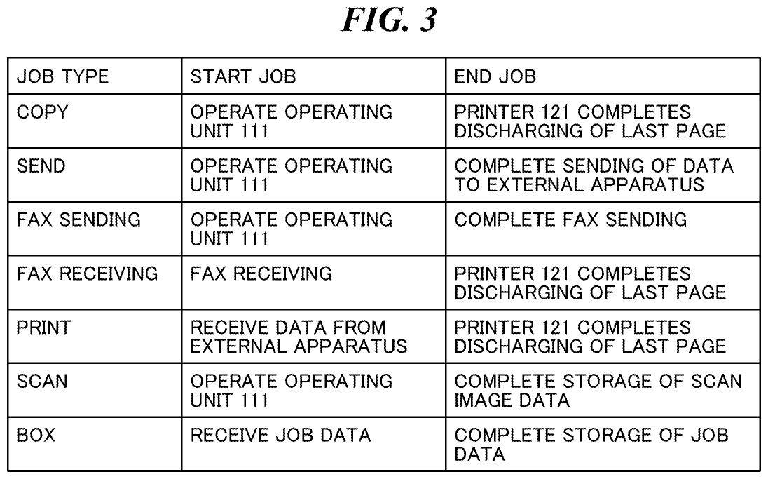

Referring to FIG. 2, upon receiving the HDD writing command (YES in step S201), the CPU 102 determines whether or not a predetermined operation relating to a process that requires writing into the HDD 109 as a prerequisite is being performed. Specifically, the CPU 102 determines whether or not an operation relating to execution of a job is being performed (step S202). In the step S202, when an operation relating to execution of one of, for example, a copy job, a send job, a fax sending job, a fax receiving job, a print job, a scan job, and a box job is being performed as shown in FIG. 3, the CUP 102 determines that the operation relating to execution of the job is being performed. On the other hand, when an operation relating to any of the jobs listed above is not being performed, the CUP 102 determines that no operation relating to execution of a job is being performed.

The operation relating to execution of a copy job means an operation performed from the time when the operating unit 111 receives an instruction to execute the copy job to the time when the printer 121 completes discharging of the last page. The operation relating to execution of a send job means an operation performed from the time when the operating unit 111 receives an instruction to execute the send job to the time when sending of data to an external apparatus connected to the LAN 113 is completed. The operation relating to execution of a fax sending job means an operation performed from the time when the operating unit 111 receives an instruction to execute the fax sending job to the time when sending of a fax is completed. The operation relating to execution of a fax receiving job means an operation performed from the time when receiving of a fax is started to the time when the printer 121 completes discharging of the last page. The operation relating to execution of a print job means an operation performed from the time when receiving of data from an external apparatus connected to the LAN 113 is started to the time when the printer 121 completes discharging of the last page. The operation relating to execution of a scan job means an operation performed from the time when the operating unit 111 receives an instruction to execute the scan job to the time when storage of generated scan image data is completed. The operation relating to execution of a box job means an operation performed from the time when receiving of job data for executing a job is started to the time when storage of the received job data is completed.

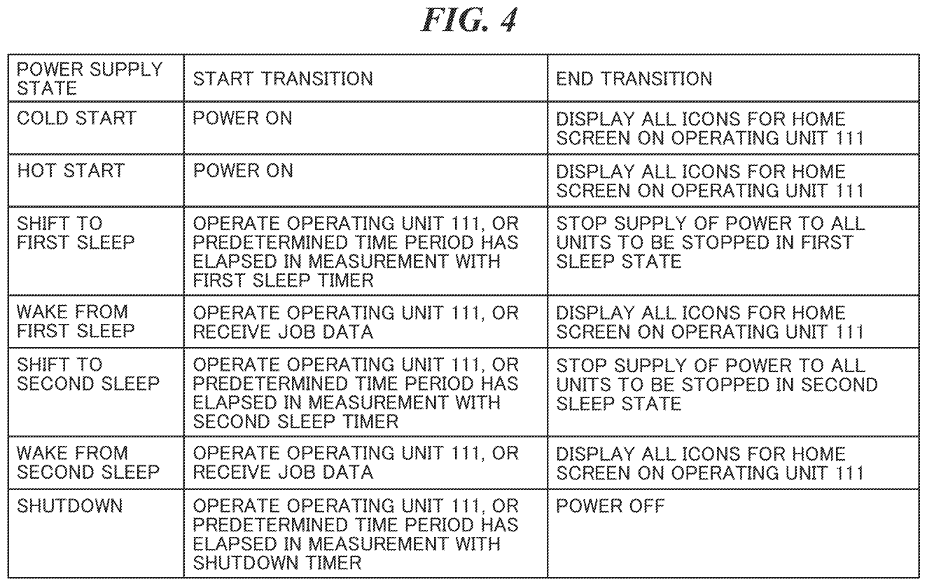

As a result of the determination in the step S202, when no operation relating to execution of a job is not being performed, the CPU 102 determines whether or not an operation relating to transition of a power supply state is being performed (step S203). In the step S203, when, for example, an operation relating to one of cold start, hot start, first shift to sleep, first wake from sleep, second shift to sleep, second wake from sleep, and shutdown is being performed as shown in FIG. 4, the CPU 102 determines that the operation relating to transition of the power supply state is being performed. On the other hand, when none of the above operations is being performed, the CPU 102 determines that the operation relating to transition of the power supply state is not being performed.

The operation relating to cold start or hot start means an operation performed from the time when the MFP 100 starts a start-up process to the time when all icons constituting a home screen of the MFP 100 are displayed on the operating unit 111. The operation relating to the first shift to sleep means an operation performed from the time when the operating unit 111 receives an instruction to shift into a first sleep state or a when a predetermined time period has elapsed in measurement using a first sleep timer (not shown) to the time when supply of power to all units for which the first sleep state is to be brought to an end is stopped. The operation relating to the first wake from sleep means an operation performed from the time when the operating unit 111 receives an instruction to wake from the first sleep state or receives job data to the time when all the icons constituting the home screen of the MFP 100 are displayed on the operating unit 111. The operation relating to the second shift to sleep means an operation performed from the time when the operating unit 111 receives an instruction to shift into a second sleep state or when a predetermined time period has elapsed in measurement using a second sleep timer (not shown) to the time when supply of power to all units for which the second sleep state is to be brought to an end is stopped. The operation relating to the second wake from sleep means an operation performed from the time when the operating unit 111 receives an instruction to wake from the second sleep state or receives job data to the time when all the icons constituting the home screen of the MFP 100 are displayed on the operating unit 111. The operation relating to shutdown means an operation performed from the time when the operating unit 111 receives an instruction to turn off the power to the MFP 100 or when a predetermined time period has elapsed in measurement using a shutdown timer (not shown) to the time when supply of power to the MFP 100 is stopped.

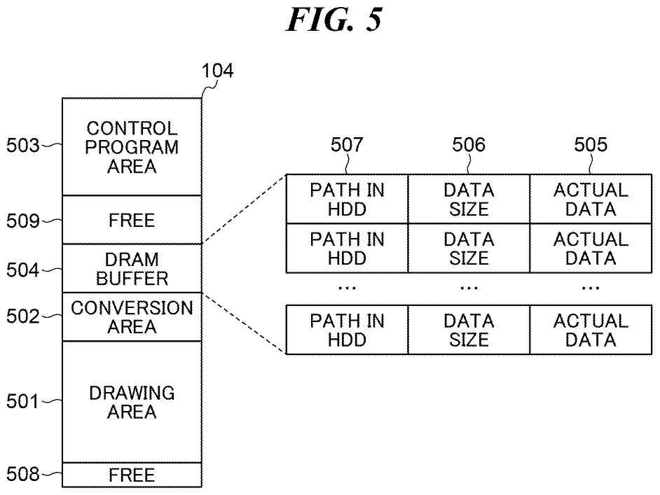

As a result of the determination in the step S203, when the operation relating to transition of the power supply state is not being performed, the CPU 102 prohibits writing into the HDD 109. The CPU 102 writes data, writing of which into the HDD 109 has been ordered in the HDD writing command, into the DRAM 104, not into the HDD 109 (step S204). As shown in FIG. 5, the DRAM 104 is divided into a plurality of areas such as a drawing area 501 in which print image data and scan image data are stored, a conversion area 502 in which data obtained by performing image processing on print image data and scan image data is stored, and a control program area 503 in which a variety of programs are stored. In the step S204, the CPU 102 writes the data into a DRAM buffer area 504 that is different from the drawing area 501, the conversion area 502, and the control program area 503. A data size 506 and a path 507 as well as actual data 505, writing of which into the HDD 109 has been ordered in the HDD writing command, are written into the DRAM buffer area 504. The data size 506 is the data capacity of the actual data 505. The path 507 is directory information on the HDD 109, which indicates a data storage location designated in the HDD writing command. In the present embodiment, the actual data 505, the data size 506, and the path 507 are held in the DRAM 104. In the following description, the actual data 505, the data size 506, and the path 507 held in the DRAM 104 will be collectively referred to as DRAM holding data. After that, the CPU 102 ends the present process.

As a result of the determination in the step S202, when the operation relating to execution of a job is being performed, or as a result of the determination in the step S203, when the operation relating to transition of the power supply state is being performed, the CPU 102 carries out a process in step S205. In the step S205, the CPU 102 determines whether or not the DRAM holding data is stored in the DRAM 104. For example, when at least one piece of data is held in the DRAM buffer area 504, the CPU 102 determines that the DRAM holding data is stored in the DRAM 104. On the other hand, when no data is held in the DRAM buffer area 504, the CPU 102 determines that the DRAM holding data is not stored in the DRAM 104.

As a result of the determination in the step S205, when the DRAM holding data is stored in the DRAM 104, the CPU 102 reads the DRAM holding data from the DRAM 104 (step S206). Then, the CPU 102 writes the actual data 505 in the DRAM holding data into the HDD 109 (step S207). In the step S207, the CPU 102 writes the actual data 505 at the storage location in the HDD 109, which is indicated by the path 507 in the DRAM holding data. For example, when a plurality of pieces of DRAM held data are stored in the DRAM 104, the CPU 102 reads all the pieces of DRAM holding data stored in the DRAM 104 in the step S206. The CPU 102 sequentially writes the actual data 505 in the respective pieces of DRAM holding data into the HDD 109 in the step S207. Then, the CPU 102 writes data into the HDD 109 based on the HDD writing command received in the step S201 (step S208) and ends the present process.

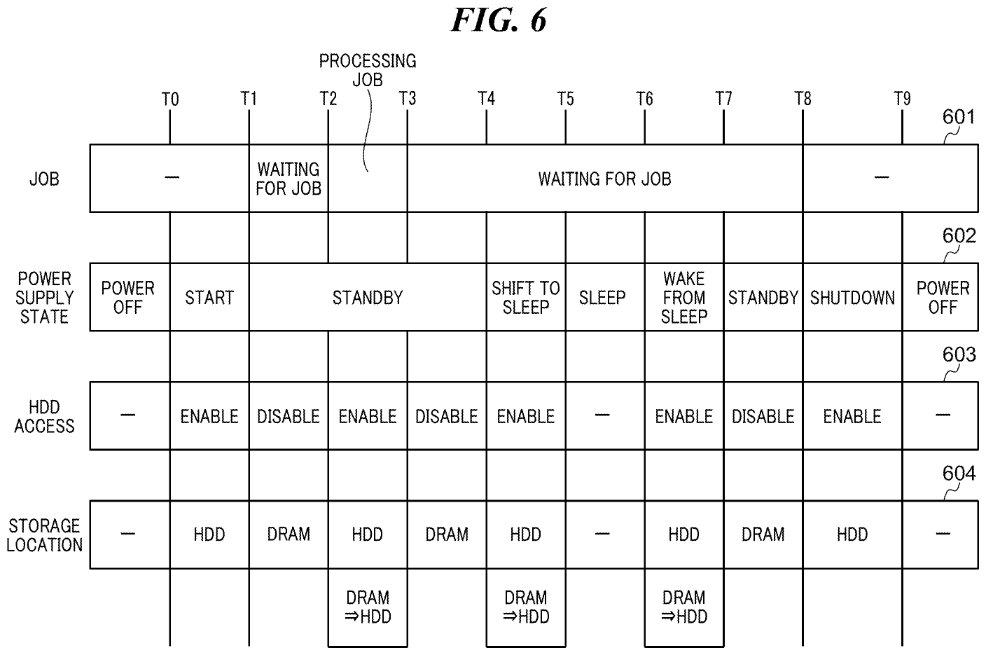

FIG. 6 is a timing chart useful in explaining operation of the MFP 100 in FIG. 1. In FIG. 6, reference numeral 601 denotes a status of a job. Reference numeral 602 denotes a power supply state of the MFP 100. Reference numeral 603 denotes whether or not access to the HDD 109 is allowed. Reference numeral 604 denotes a storage location for data designated in a HDD writing command.

From the time when the MFP 100 starts a start-up process to the time when all the icons constituting the home screen of the MFP 100 are displayed on the operating unit 111 as in a time period from T0 to T1, access to the HDD 109 is allowed in the MFP 100. Data designated in an HDD writing command received in this time period is written into the HDD 109 (see, for example, the step S208).

In a case where there is no transition in the power supply state of the MFP 100, and the MFP 100 is waiting for a job as in a time period from T1 to T2, a time period from T3 to T4, and a time period from T7 to T8, access to the HDD 109 is prohibited in the MFP 100. Data designated in an HDD writing command received in this time period is written into the DRAM 104 (see, for example, the step S204).

In a case where an operation relating to execution of a job is being performed as in a time period from T2 to T3, access to the HDD 109 is allowed in the MFP 100. Data designated in an HDD writing command received in this time period is written into the HDD 109. Also, actual data in the DRAM holding data written into the DRAM 104 during, for example, the time period from T1 to T2 is written into the HDD 109 (see, for example, the step S207).

In a case where an operation relating to transition of the power supply state as in a time period from T4 to T5, a time period from T6 to T7, and a time period from T8 to T9, access to the HDD 109 is allowed in the MFP 100. Data designated in an HDD writing command received in this time period is written into the HDD 109. Also, actual data in the DRAM holding data written into the DRAM 104 in, for example, the time period from T3 to T4 and the time period from T7 to T8 is written into the HDD 109.

According to the embodiment described above, whether or not to allow writing into the HDD 109 is determined based on an operating state of the MFP 100. As a result, regardless of an amount of data to be stored, whether or not to write the data into the HDD 109 is controlled based on an operating state of the MFP 100, making it possible to decrease the frequency of access to the HDD 109. As a result, the risk of failure of the HDD 109 can be reduced.

In the embodiment described above, when the MFP 100 is performing a predetermined operation relating to a process that requires writing into the HDD 109 as a prerequisite, writing into the HDD 109 is allowed, and when the MFP 100 is not performing the predetermined operation, writing into the HDD 109 is prohibited. As a result, the frequency of access to the HDD 109 can be decreased without delaying the process that requires writing into the HDD 109 as a prerequisite.

Moreover, in the embodiment described above, when the MFP 100 is not performing the predetermined operation, the actual data 505, writing of which into the HDD 109 has been ordered, is written into the DRAM 104. Namely, when writing into the HDD 109 is prohibited, the actual data 505, writing of which into the HDD 109 has been ordered, is written into the DRAM 104. As a result, the risk of failure of the HDD 109 can be reduced, and also, the actual data 505, writing of which into the HDD 109 has been ordered, can be held when the MFP 100 is not performing the predetermined operation.

In the embodiment described above, when the MFP 100 is performing the predetermined operation, and actual data is stored in the DRAM 104, all of the actual data stored in the DRAM 104 is sequentially written into the HDD 109. As a result, the number of the times that the HDD 109 is accessed can be decreased as compared to a case where pieces of actual data are written into the HDD 109 at different times.

It should be noted that the storage device provided in the MFP 100 may not be the HDD 109 but may be another storage device such as an SSD that can be accessed a limited number of times.

Moreover, in the embodiment described above, not directory information indicating a storage location in the HDD 109 but a drive name of the HDD 109 may be held as the path 507 in the DRAM holding data. For example, assume that when a directory structure of the HDD 109 is /sdb1/data/print/job1/page1.jpg, a directory structure of the DRAM buffer area 504 is /sda1/data/print/job1/page1.jpg, which is different from that of the HDD 109 only in its drive name. In this case, the MFP 100 holds “sdb1”, which indicates the drive name of the HDD 109, as the path 507 in the DRAM holding data.

In the embodiment described above, in the arrangement in which data designated in an HDD writing command is held in a predetermined area in the DRAM 104 and then written into the HDD 109, a time period over which the data is held in the predetermined area in the DRAM 104 may be controlled.

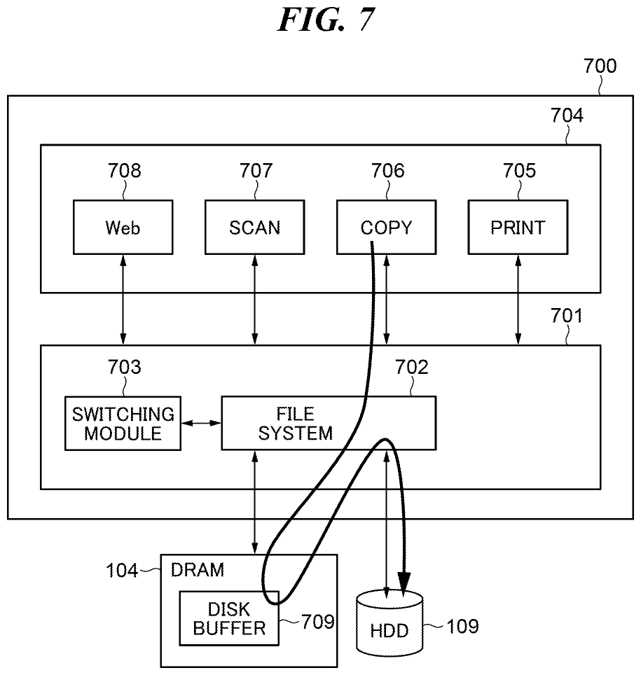

FIG. 7 is a block diagram useful in explaining an arrangement of software modules in the MFP 100 in FIG. 1. Processes implemented by the software modules 700 are implemented by the CPU 102 executing programs stored in the ROM 106 and the HDD 109.

The software modules 700 include an OS 701 (operating system) 701 as a module. The software modules 700 also include, in its application layer 705, at least one application as a module, for example, a print app 705, a copy app 706, a scan app 707, and a Web app 708.

The OS 701 is a basic software module that is a core of a software module group controlling the system of the MFP 100. The OS 701 is comprised of a file system 702 and a switching module 703. Although in the present embodiment, it is assumed that the switching module 703 is included in the OS 701, this is not limitative, but the switching module 703 may be included in another module other than the OS 701. The file system 702 provides a function of accessing data stored in the DRAM 104 and the HDD 109 and a function of searching for the data. The switching module 703 controls the holding time period described above according to whether or not access to the HDD 109 is allowed. The print app 705 is an application for executing a print job. The copy app 706 is an application for executing a copy job. The scan app 707 is an application for executing a scan job. The Web app 708 is an application for executing a job using a Web. Each application in the application layer 704 sends an HDD writing command to the file system 702 when it becomes necessary to write data into the HDD 109 during execution of a job.

In the MFP 100, a sector size of the HDD 109 is 512 bytes or 4K bytes. When each application in the application layer 704 frequently accesses the HDD 109 every small size such as several bytes, the efficiency of data storage in the HDD 109 and the efficiency of bus transfer between the controller 101 and the HDD 109 will decrease. To avoid such a situation, the file system 702 temporarily stores data, which is designated in an HDD writing command received from each application in the application layer 704, in a disk buffer 709, and when a holding time period set in advance has elapsed, the file system 702 writes the data stored in the disk buffer 709 into the HDD 109. In the present embodiment, a free space such as an area 508 or 509 in FIG. 5 is allocated as the disk buffer 709. Alternatively, an area specified in advance is used as the disk buffer 709.

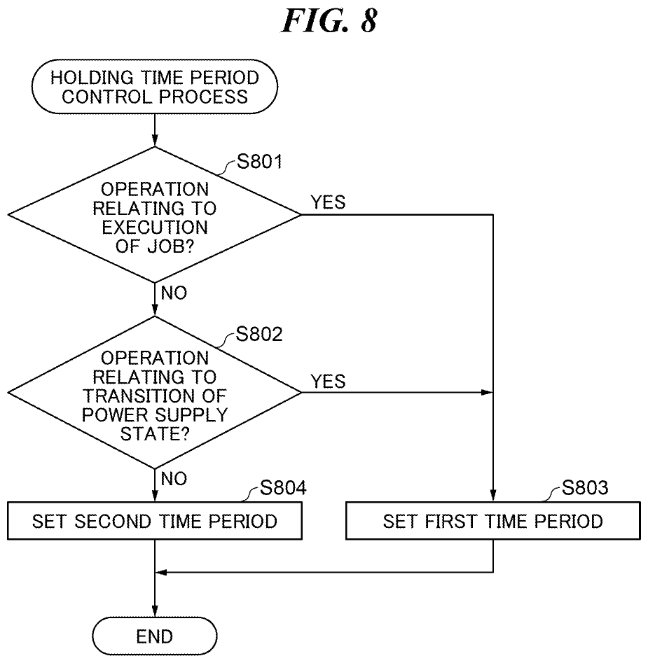

FIG. 8 is a flowchart showing the procedure of a holding time period control process which is carried out by the MFP 100 in FIG. 1. The process in FIG. 8 is implemented by the CPU 102 executing a program stored in the ROM 106 or the HDD 109. The process in FIG. 8 is carried out when, for example, an HDD writing command is issued.

Referring to FIG. 8, the CPU 102 determines whether or not an operation relating to execution of a job is being performed (step S801). In the step S801, the same determination process as in the step S202 described above is carried out.

As a result of the determination in the step S801, when the operation relating to execution of a job is not being performed, the CPU 102 determines whether or not an operation relating to transition of a power supply state is being performed (step S802). In the step S802, the same determination process as that in the step S203 described above is carried out.

As a result of the determination in the step S802, when the operation relating to transition of the power supply state is being performed, or as a result of the determination in the step S801, when the operation relating to execution of a job is being performed, the CPU 102 sets a first time period as the holding time period for the disk buffer 709 (step S803). The first time period is, for example, about five seconds. After that, the CPU 102 ends the present process.

As a result of the determination in the step S802, when the operation relating to transition of the power supply state is not being performed, the CPU 102 sets a second time period, which is longer than the first time period, as the holding time period for the disk buffer 709 (step S804). The second time period is, for example, about five hours. After that, the CPU 102 ends the present process.

The time at which the process in FIG. 8 described above is carried out is not limited to the time at which an HDD writing command is issued. For example, the process in FIG. 8 described above may be carried out at predetermined intervals set in advance.

Moreover, although in the process in FIG. 8 described above, the step S802 is executed after execution of the step S801, the order in which the steps S801 and S802 are executed is not limited to this. For example, the step S801 may be executed after execution of the step S802, or the steps S801 and S802 may be executed in parallel.

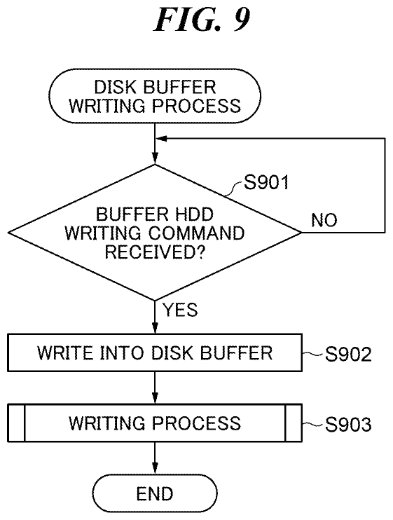

FIG. 9 is a flowchart showing the procedure of a disk buffer writing process which is carried out by the MFP 100 in FIG. 3. The process in FIG. 9 is implemented by the CPU 102 executing a program stored in the ROM 106 or the HDD 109. The process in FIG. 9 is carried out when, for example, an HDD writing command that requires writing into the disk buffer 709 as described above (hereafter referred to as “the buffer HDD writing command”) is issued.

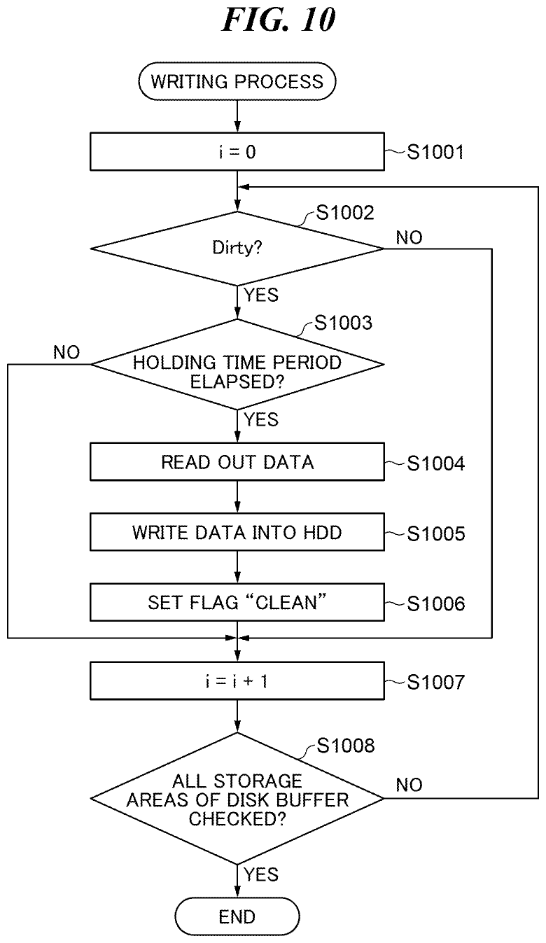

Referring to FIG. 9, upon receiving the buffer HDD writing command (YES in step S901), the CPU 102 writes data designated in the buffer HDD writing command into the disk buffer 709 (step S902). For a storage area in which the data has been written among a plurality of storage areas constituting the disk buffer 709, the CPU 102 sets a flag “Dirty” indicating that the data has been stored. At this time, the CPU 102 carries out the holding time period control process in FIG. 8 described above in parallel to set the holding time period for the disk buffer 709. Then, the CPU 102 carries out a writing process in FIG. 10, which will be describe later (step S903), to write the data, which was written in the disk buffer 709, into the HDD 109. After that, the CPU 102 ends the present process.

FIG. 10 is a flowchart showing the procedure of the writing process in the step S903 in FIG. 9.

Referring to FIG. 10, the CPU 102 initializes a disk buffer number i, which indicates a storage area to which the CPU 102 will refer in the disk buffer 709, to 0 (step S1001). Then, the CPU 102 identifies which storage area corresponds to the ith one among the plurality of storage areas constituting the disk buffer 709 and determines whether or not a flag for the identified storage area is “Dirty” (step S1002).

As a result of the determination in the step S1002, when the flag for the identified storage area is “Dirty”, the CPU 102 finds a date and time at which data was written into the identified storage area. The CPU 102 determines whether or not the found date and time has passed the holding time period for the disk buffer 709 set in the holding time period control process in FIG. 8 described above (step S1003).

As a result of the determination in the step S1003, when the found date and time has not passed the holding time period, or as a result of the determination in the step S1002, when the flag for the identified storage area is not “Dirty”, the CPU 102 carries out a process in step S1007, which will be described later.

As a result of the determination in the step S1003, when the found date and time has passed the holding time period, the CPU 102 reads out data from the identified storage area (step S1004). Then, the CPU 102 writes the data read out in the step S1004 into the HDD 109 (step S1005). After that, the CPU 102 sets a flag “Clean” for the identified storage area to indicate that the data has already been written into the HDD 109 (step S1006) and increments the disk buffer number I (step S1007). Then, the CPU 102 determines whether or not all the storage areas in the disk buffer 709 have been checked (step S1008).

As a result of the determination in the step S1008, when any of the storage areas in the disk buffer 709 has not been checked, the process returns to the step S1002. As a result of the determination in the step S1008, when all the storage areas in the disk buffer 709 have been checked, the CPU 102 ends the present process.

In the embodiment described above, when the MFP 100 is performing the predetermined operation, the first time period is set as the holding time period for the disk buffer 709, and when the MFP 100 is not performing the predetermined operation, the second time period longer than the first time period is set as the holding time period for the disk buffer 709. Namely, when MFP 100 is not performing the predetermined operation, data is held in the disk buffer 709 for a relatively long time period, causing the frequency of access to the HDD 109 to be decreased. As a result, the risk of failure of the HDD 109 can be reduced.

Moreover, in the embodiment described above, the predetermined operation includes an operation relating to execution of a job. As a result, the risk of the failure of the HDD 109 can be reduced without delaying execution of a job.

In the embodiment described above, the predetermined operation includes an operation relating to transition of a power supply state. As a result, the risk of failure of the HDD 109 can be reduced without delaying transition of a power supply state.

Moreover, in the embodiment described above, the MFP 100 is an image forming apparatus that carries out an image forming process, and hence even if it becomes necessary to frequently write image data into the HDD as the image forming process is carried out, the risk of failure of the HDD 109 can be reduced.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-040666, filed Mar. 6, 2019, which is hereby incorporated by reference herein in its entirety.

What is claimed is:

1. An information processing apparatus equipped with a storage device that can be accessed a limited number of times, comprising:
a control unit configured to perform control to write data into the storage device,
wherein the control unit determines whether or not to allow writing into the storage device based on an operating state of the information processing apparatus.

2. The information processing apparatus according to claim 1, wherein in a case where the information processing apparatus is performing a predetermined operation relating to a process that requires writing into the storage device as a prerequisite, the control unit allows writing into the storage device, and in a case where the information processing apparatus is not performing the predetermined operation, the control unit prohibits writing into the storage device.

3. The information processing apparatus according to claim 2, further comprising another storage device that is different from the storage device,
wherein in a case where the information processing apparatus is not performing the predetermined operation, the control unit performs control to write actual data, writing of which into the storage device has been ordered, into the other storage device.

4. The information processing apparatus according to claim 3, wherein in a case where the information processing apparatus is performing the predetermined operation, and the actual data is stored in the other storage device, the control unit performs control to sequentially write all of the actual data stored in the other storage device into the storage device.

5. The information processing apparatus according to claim 1, further comprising:
a holding unit; and
a setting unit configured to set a holding time period for which data is held in the holding unit,
wherein after holding data in the holding unit for the holding time period, the control unit performs control to write the data into the storage device,
wherein in a case where the information processing apparatus is performing a predetermined operation relating to a process that requires writing into the storage device as a prerequisite, a first time period is set as the holding time period, and in a case where the information processing apparatus is not performing the predetermined operation, a second time period longer than the first time period is set as the holding time period.

6. The information processing apparatus according to claim 2, wherein the predetermined operation includes an operation relating to execution of a job.

7. The information processing apparatus according to claim 2, wherein the predetermined operation includes an operation relating to transition of a power supply state of the information processing apparatus.

8. The information processing apparatus according to claim 1, wherein the information processing apparatus is an image forming apparatus that carries out an image forming process.

9. A control method for an information processing apparatus equipped with a storage device that can be accessed a limited number of times, comprising:
a control step of performing control to write data into the storage device,
the control step comprises determining whether or not to allow writing into the storage device based on an operating state of the information processing apparatus.

10. A non-transitory computer-readable storage medium storing a program for causing a computer to execute a control method for an information processing apparatus equipped with a storage device that can be accessed a limited number of times, comprising:
a control step of performing control to write data into the storage device,
the control step comprises determining whether or not to allow writing into the storage device based on an operating state of the information processing apparatus.
